(19) United States
(12) Patent Application Publication
(10) Pub. No.: US 2009/0273922 A1
(43) Pub. Date: Nov. 5, 2009

(54) Street light utilizing combination low-pressure sodium and metal halide light sources

(76) Inventors: Tseng Fong Ho, Hong Kong (CN); Kuen Shan Chan, Hong Kong (CN); Kuen Lam, Hong Kong (CN)

Correspondence Address: ERIC HANSCOM, 7395 PORTAGE WAY, CARLSBAD, CA, 92011, US

(21) Appl. No.: 12/115,222

(22) Filed: May 5, 2008

(51) Int. Cl. F21S 8/08; F21L 13/00

(52) U.S. Cl. 362/183; 362/228

(57) ABSTRACT

A street light that uses both a low-pressure sodium vapor bulb and a metal halide bulb is disclosed. The combination of these two light bulbs creates an efficient light source that is highly effective in bad weather conditions as well as able to provide good color differentiation. Further, the street light can be battery powered, where the batteries are recharged by solar cells, wind turbines, or both. A self-sufficient cost-effective street light is produced that uses renewable energy to provide light that has high penetration and wide color spectrum characteristics.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of street lights, and more specifically toward a street light that uses both a low-pressure sodium vapor bulb and a metal halide bulb. The combination of these two light bulbs creates an efficient light source that is highly effective in bad weather conditions as well as able to provide good color differentiation. Further, the street light can be battery powered, where the batteries are recharged by solar cells, wind turbines, or both. A self-sufficient cost-effective street light is produced that uses renewable energy to provide light that has high penetration and wide color spectrum characteristics.

Street lights are used to illuminate roads and other areas during the night to increase visibility of objects for motorists and pedestrians alike. The first electric street light used an arc lamp to produce light. Then followed the use of incandescent light bulbs near the end of the 19^{th} century. Currently, street lights most commonly use high intensity discharge lamps.

Monochromatic light is often sufficient to illuminate many objects and has the added benefit of being able to penetrate fog and other low visibility situations. However, there are occasions where differentiating color can be important. For example, if the street light is used for security purposes, identifying the color of a car or the color of an individual's clothes may be important. This requires a light source with a wide bandwidth, but these light sources tend not to be able to penetrate fog.

A low-pressure sodium vapor bulb, or lamp, provides a low-intensity discharge of light from a linear lamp shade. It uses an outer envelope of glass coated with an infrared reflecting layer that holds back infrared wavelengths while releasing visible light. Two U-shaped glass pipes that hold solid sodium are inside of the outer envelope. When the bulb is turned on, it first emits a dim red or pink light, which then turns to bright yellow as the sodium is vaporized. This bulb releases monochromatic light at a wavelength of approximately 589.3 nm. While this light is highly effective at penetrating fog and other low-visibility situations, it is difficult to distinguish colors under this light because of its narrow bandwidth. The low-pressure sodium vapor bulb, however, is an efficient source of light that can produce up to 200 lumens per watt and this output generally does not decline with age of the bulb. High-pressure sodium vapor bulbs, on the other hand, produce a wider bandwidth of light, but contain additional elements, such as mercury, that are considered environmental hazards. Further, the efficiency of this type of bulb is less than its low-pressure counterpart, in the range of 100 to 150 lumens per watt.

Metal halide bulbs, or lamps, are known for their high light output compared to their size. The bulb has an outer glass shield that protects the inner components, which includes a fused quartz arc tube and its embedded tungsten electrodes. The arc tube creates an electric arc through a mixture of gasses, where the gases are a variety of metal halides. A wide bandwidth of light is produced from metal halide bulbs allowing for good color differentiation. However, metal halide bulbs are not as efficient at producing light as low-pressure sodium vapor bulbs, as metal halide bulbs generally produce 65-115 lumens per watt.

Solar cells and wind turbines are well known for their ability to create clean energy. Solar cells transform light, usually from the sun, into electrical energy. A drawback of solar cells is that they do not produce electricity without light, and therefore cannot be used to produce light at night without the use of batteries. Further, a large surface area of solar cells is required to produce a sizable amount of electricity. Wind turbines, on the other hand, convert wind energy into electrical energy. An obvious drawback of wind turbines is that they do not produce electrical energy if there is no wind.

The prior art has mainly focused on the combination of high pressure bulbs. U.S. Pat. No. 4,570,209, to Wittlin, teaches using high pressure sodium light sources with metal halide light sources to light a room. However, this patent does not contemplate the use of low pressure sodium light sources for use with street lights.

U.S. Pat. No. 6,796,700, to Kraft, also teaches a light source that utilizes both metal halide bulbs with high pressure sodium bulbs. The light source is intended to be used in a flat panel application, such as a billboard. Thus, the use of a high-pressure sodium bulb that can produce a wider bandwidth of light at the expense of being less efficient.

U.S. Pat. No. 5,239,232, to Heider et al., discloses a high pressure discharge lamp utilizing multiple different metal halides, one of which is sodium. While this discharge lamp may have a wide bandwidth of light, it is included only in one bulb. Thus, it does not contemplate a light source where one bulb can be selectively turned on and off to change the energy consumed by the device and the bandwidth of light produced.

U.S. Patent Application 2005/0253528, to Schoeller et al., also discloses the use of multiple different metal halides in a single bulb, specifically for headlights for motor vehicles. As with Heider et al., it does not contemplate a light source where one bulb can be selectively turned on and off to change the energy consumed by the device and the bandwidth of light produced.

Thus there has existed a long-felt need for a street light that can produce light that can penetrate weather conditions such as fog and heavy rain. It should also have the ability to show color differentiation when needed. This device should be energy efficient and preferably use clean energy. Further, it is beneficial if the device were completely self sufficient such that it can be placed anywhere without requiring access to utility power.

The current invention provides just such a solution by having a street light that uses both a low-pressure sodium vapor bulb and a metal halide bulb. The combination of these two light bulbs creates an efficient light source that is highly effective in bad weather conditions as well as able to provide good color differentiation. Further, the street light can be battery powered, where the batteries are recharged by solar cells, wind turbines, or both. A self-sufficient cost-effective street light is produced that uses renewable energy to provide light that has high penetration and wide color spectrum characteristics.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention. Throughout this application, the terms “bulb” and “lamp” are used interchangeably.

### SUMMARY OF THE INVENTION

The current invention provides a street light that produces light which can be used for penetrating inclement weather conditions as well as provide light sufficient for color differentiation. It uses a low-pressure sodium vapor bulb and a metal halide bulb, and should be able to use both bulbs, either bulb, or neither bulb. Additionally, the current invention is energy efficient in that it has a high lumens to watt ratio, and can run off of battery power, solar power, wind turbine power, or any combination thereof.

It is a principal object of the invention to provide a street light that produces light with high penetration through low visibility situations such as fog and heavy rain.

It is another object of the invention to provide a street light that at the same time can produce a wide bandwidth of light to allow for color differentiation.

It is a further object of the invention to provide a street light that is self sufficient such that it need not be connected to utility power.

It is a final object of this invention to provide a street light that is powered by clean energy.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a side view of the street light.

FIG. 2 is a bottom view of the light box.

FIG. 3 is a top view of the range of penetration of the different light produced from the street light.

### DETAILED DESCRIPTION OF THE FIGURES

Many aspects of the invention can be better understood with reference to the drawings below. The components in the drawings are not necessarily drawn to scale. Instead, emphasis is placed upon clearly illustrating the components of the present invention. Moreover, like reference numerals designate corresponding parts through the several views in the drawings.

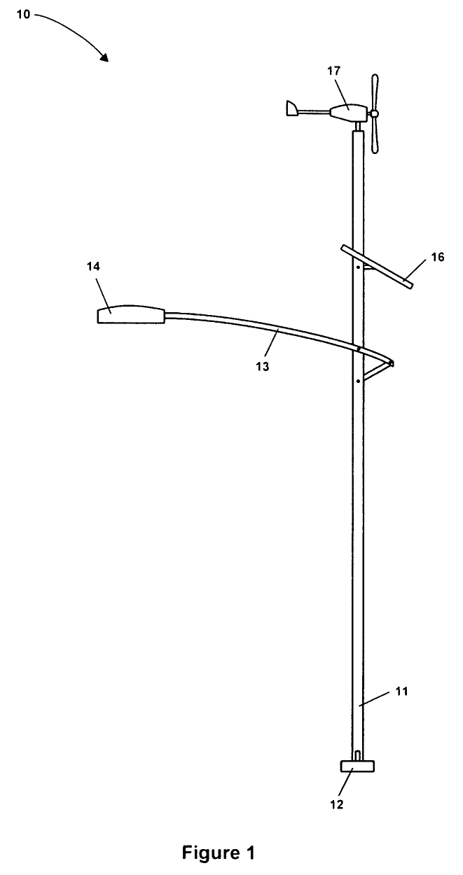

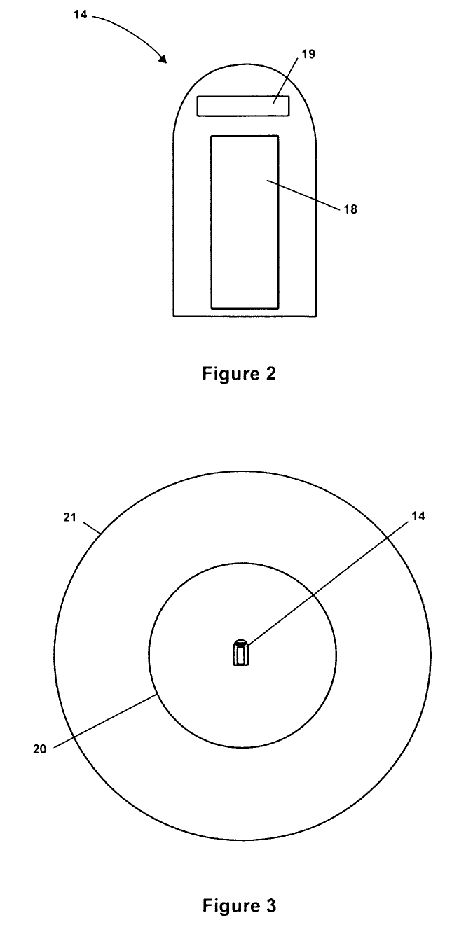

FIG. 1 is a side view of the street light. The street light 10 includes a base 12 that supports a pole 11. The base 12 can be secured to a stable surface such as cement. Alternatively, the pole 11 can be driven into the ground to support itself without the use of a base or other means of attachment. In fact, the pole 11 can be supported by any means so long as the pole 11 is able to support the other various components of the street light 10. Extending from the pole 11 is an arm 13 that has a light box 14 attached to its end. The light box 14 produces light from two different types of bulbs: a low-pressure sodium vapor bulb and a metal halide bulb (shown in FIG. 2). Moving further up the pole 11, there are solar cells 16. These solar cells 16 can be used to convert light, such as from the sun, into electrical energy. Since the light will generally be used at night, there will be little to no light incident upon the solar cells 16 to convert into electrical energy. Therefore, a battery (not shown) should be included with the street light 10 to store energy when neither bulb is in use, and to provide energy when a bulb is in use. On the top of the pole 11, there can be a wind turbine 17. The wind turbine 17 should preferably be allowed to swivel around the top of the pole and designed such that the wind turbine 17 is always facing into the wind. The wind turbine 17 produces electricity from the wind. It is also possible that the electricity generated from the wind turbine 17 is stored in a battery such that the power may be used at a later time.

While it is possible that the solar cells 16 or the wind turbine 17 individually could provide a sufficient amount of electrical energy to power the light box 14 from dawn until dusk, it is preferable that the street light 10 have both. During the day, the solar cells 16 will produce energy to be stored in a battery. Also, whenever there is wind, the wind turbine 17 will also produce energy to be stored in the battery. On a cloudy day when there is less light, the solar cells 16 will generally produce less electrical energy. However, there will generally be more wind and therefore the wind turbine 17 will produce more energy to compensate for the lower amount of electrical energy produced by the solar cells 16. Further, at night, the wind turbine 17 can continue to create electrical energy, assuming there is wind, to recharge the battery, power the light box 14, or both. It may also be preferable to connect the street light 10 to utility power for backup purposes, whereby the street light 10 is designed to mainly use solar and wind power, but if there is insufficient power from these sources, the street light 10 is able to utilize utility power.

The solar cell 16 and wind turbine 17 can also be located in different places along the pole. For example, the wind turbine 17 could be placed below the solar cells 16. Even though it is preferable to allow the wind turbine 17 to rotate such that it is always facing into the wind, certain situations may allow for a wind turbine 17 that is set in a fixed position. Also, multiple solar cells 16 or multiple wind turbines 17 could be used on a single street light 10. Further, the street light 10 can include multiple light boxes 14 either on the same arm 13 or on additional arms 13 that are attached to the pole in other various locations.

FIG. 2 is a bottom view of the light box. The light box 14 includes a low-pressure sodium vapor bulb 18 and a metal halide bulb 19. The low-pressure sodium vapor bulb 18 is used for light penetration. Not only does it produce light efficiently, but it can provide light that penetrates through fog and other inclement weather more effectively than other types of light. The metal halide bulb 19, on the other hand, produces light that works well for differentiating colors, but doesn't have the penetrating qualities of the low-pressure sodium vapor bulb 18. When these two bulbs are used in combination, though, the resulting light box 14 produces light that has high penetration qualities along with the ability for good color differentiation. Granted, the light that is able to penetrate the furthest does not have good color differentiation, but objects located close to the light box 14 will have good color definition that would not have been possible without the white light from the metal halide bulb 19.

It is contemplated that different types of bulbs can be used in place of the metal halide bulb to create a source of white light, including LED bulbs. LED bulbs, or combinations of LED bulbs, can be used to efficiently create a wide spectrum of light. Currently, commercially available LEDs generally can create 18-22 lumens per watt, but some experimental LEDs have been quoted as producing 150 lumens per watt or more.

It is contemplated that the bulbs, from time to time or on a regular basis, may not be used simultaneously. For example, during periods near dawn and dusk, only the metal halide bulb may be illuminated to help with color differentiation. The low-pressure sodium vapor bulb is not needed because of the low-level of light already present. Later at night, where light pollution is an issue, the low-pressure sodium vapor bulb may be illuminated while the metal halide bulb is not. If the street light is used for security purposes, it may further include a motion sensor. The low-pressure sodium vapor bulb may be lit continuously while the metal halide bulb is illuminated only when the motion sensor detects motion. The metal halide bulb may be illuminated only when the motion sensor detects motion, or for a set period of time after it has sense the motion. This will provide low-intensity light continuously while giving color differentiation when needed.

A controller that utilizes “fuzzy” logic may also be used in the device. The controller has the ability to sense the level of charge in the battery. The level of charge is then used to determine the number of hours that each or both bulbs should operate. For example, if the controller determines that there is a sufficient charge in the batteries to operate both lights throughout the night, the controller will power both lights throughout the night. However, if there is insufficient charge remaining in the battery to power both lights throughout the night, then it may utilize only the low-pressure sodium vapor bulb throughout the night and the metal halide bulb during peak usage periods. Alternatively, if there is insufficient charge remaining in the battery, the controller may utilize only the low-pressure sodium vapor bulb throughout the night and power the metal halide bulb only when the motion sensor senses motion. In another alternative, if there is insufficient charge remaining in the battery, both bulbs may be illuminated for a set period of time, and then only powered when the motion sensor senses power.

The two different light sources can also be placed in separate boxes. For example, the street light could include a light box with one or more low-pressure sodium vapor bulbs, but no metal halide bulbs. Another light box could include one or more metal halide bulbs, but not low-pressure sodium vapor bulbs. These light boxes could be placed on the same arm or on different arms located about the pole.

A timer can be included with the street light such that one or both of the bulbs will be turned on and off at specified times. These times can be consistent every day, or can change depending on the day of the week, month, or year. Alternatively, the street light can include a light sensor that is capable of sensing light. In this embodiment, the low-pressure sodium vapor bulb, the metal halide bulb, or both, can turn on when the light sensor senses a sufficient amount of darkness. The low-pressure sodium vapor bulb, the metal halide bulb, or both, can turn be turned off when the light sensor senses a sufficient amount of light. For example, the light sensor could be set such that it turns on the low-pressure sodium vapor bulb approximately at dusk and turns off the low-pressure sodium vapor bulb approximately at dawn. It could also turn the low-pressure sodium vapor bulb on a set period of time after dusk, such as one hour.

FIG. 3 is a top view of the range of penetration of the different light used in the street lamp. The light box 14 produces light from a metal halide bulb and a low-pressure sodium vapor bulb. The penetration of light from the metal halide bulb 20 will have a smaller radius than the penetration of light from the low-pressure sodium vapor bulb 21. Therefore, when both bulbs are illuminated, the light from the low-pressure sodium vapor bulb will light up a larger area while the light from the metal halide bulb will give color differentiation in a smaller area.

The street light of the current invention produces low intensity light that can penetrate through bad weather conditions while at the same time also produce light that is useful for color differentiation. It can be self-powered by clean energy by using solar cells, wind turbines, or both. This allows for street lights to be deployed in areas where utility power is not available while having a light source with good penetration and color differentiation capabilities.

What I claim is:

1. A street light for efficiently producing light comprising a low-pressure sodium vapor bulb and a source for white light,
where the low-pressure sodium vapor bulb is used to produce low-intensity light, where the source for white light is used to produce light of a wider bandwidth than the light produced from the low-pressures sodium vapor bulb, where the low-pressure sodium vapor bulb is used to produce light that penetrates further than the light produced from the source for white light,
where the street light may or may not be connected to utility power.

2. The street light of claim 1, where the source for white light is a metal halide bulb.

3. The street light of claim 1, where the street light further comprises a light box, where the light box contains the low-pressure sodium vapor bulb and the source for white light.

4. The street light of claim 1, where the street light further comprises a first light box and a second light box, where the first light box contains the low-pressure sodium vapor bulb and the second light box contains the source for white light.

5. The street light of claim 1, where the street light further comprises a battery and solar cells,
where the battery is used to power the low-pressure sodium vapor bulb, the source for white light, or both,
where the solar cells are capable of converting light into electrical energy, where the electrical energy can then be stored in the battery.

6. The street light of claim 1, where the street light further comprises a battery and a wind turbine,
where the battery is used to power the low-pressure sodium vapor bulb, the source for white light, or both,
where the wind turbine is capable of converting wind energy to electrical energy, where the electrical energy can then be stored in the battery.

7. The street light of claim 1, where the low-pressure sodium vapor bulb and the source for white light are always used simultaneously.

8. The street light of claim 1, where the street light further comprises a light sensor.

9. The street light of claim 8, where the low-pressure sodium vapor bulb is on continuously from at least dusk until at least dawn while the source for white light is not on continuously from dusk until dawn.

10. The street light of claim 1, where the street light further comprises a motion sensor, where the motion sensor is capable of detecting motion, and where the low-pressure sodium vapor bulb, the source for white light, or both are turned on when the motion sensor detects motion.

11. The street light of claim 10, where the metal halide bulb is turned on for a set period of time when the motion sensor detects motion.

12. The street light of claim 1, where the street light further comprises a timer, where the timer can cause the low-pressure sodium vapor bulb and the source for white light, individually or together, to turn on and off at set times during a 24-hour period, where these set times may vary depending on the day of the week, month, or year.

13. A street light for efficiently producing light comprising a low-pressure sodium vapor bulb, a metal halide bulb, and a battery,
where the low-pressure sodium vapor bulb is used to produce low-intensity light, where the metal halide bulb is used to produce light of a wider bandwidth than the light produced from the low-pressures sodium vapor bulb, where the low-pressure sodium vapor bulb is used to produce light that penetrates further than the light produced from the metal halide bulb,
where the battery is used to power the low-pressure sodium vapor bulb, the metal halide bulb, or both, and where the street light may or may not be connected to utility power.

14. The street light of claim 13, where the street light further comprises solar cells, where the solar cells are capable of converting light into electrical energy, where the electrical energy can then be stored in the battery.

15. The street light of claim 13, where the street light further comprises a wind turbine, where the wind turbine is capable of converting wind energy to electrical energy, where the electrical energy can then be stored in the battery.

16. The street light of claim 13, where the street light further comprises a light sensor, where the low-pressure sodium vapor bulb is on continuously from at least dusk until at least dawn while the metal halide bulb is not on continuously from dusk until dawn.

17. The street light of claim 13, where the street light further comprises a motion sensor, where the metal halide bulb is turned on for a set period of time when the motion sensor detects motion.

18. The street light of claim 13, where the street light further comprises a timer, where the timer can cause the low-pressure sodium vapor bulb and the metal halide bulb, individually or together, to turn on and off at set times during a 24-hour period.

19. A street light for efficiently producing light comprising a low-pressure sodium vapor bulb, a metal halide bulb, solar cells, a wind turbine, and a battery, where the low-pressure sodium vapor bulb is used to produce low-intensity light, where the metal halide bulb is used to produce light of a wider bandwidth than the light produced from the low-pressures sodium vapor bulb, where the low-pressure sodium vapor bulb is used to produce light that penetrates further than the light produced from the metal halide bulb
where the battery is used to power the low-pressure sodium vapor bulb, the metal halide bulb, or both, and where the street light may or may not be connected to utility power,
where the solar cells are capable of converting light into electrical energy, where the electrical energy can then be stored in the battery,
where the wind turbine is capable of converting wind energy to electrical energy, where the electrical energy can then be stored in the battery.

20. The street light of claim 19, where the street light further comprises a light sensor, where the low-pressure sodium vapor bulb is on continuously from at least dusk until at least dawn, and
where the street light further comprises a motion sensor, where the metal halide bulb is turned on for a set period of time when the motion sensor detects motion.
